(19) United States
(12) Patent Application Publication
(10) Pub. No.: US 2006/0046564 A1
(43) Pub. Date: Mar. 2, 2006

(54) Flexible transmission line connector and method for connecting

(75) Inventors: Donald J. Stanford, Norway, ME (US); Kevin J. Lorenz, Raymond, ME (US); Andre J. Skalina, Portland, ME (US); James L. Thomas, Otisfield, ME (US); Christopher D. Brown, Raymond, ME (US)

Correspondence Address: BAKER & HOSTETLER LLP;Washington Square, Suite 1100, 1050 Connecticut Avenue, N.W., WASHINGTON, DC, 20036, US

(73) Assignee: SPX Corporation

(21) Appl. No.: 10/924,845

(22) Filed: Aug. 25, 2004

(51) Int. Cl. H01R 9/05

(52) U.S. Cl. 439/578

(57) ABSTRACT

An outer conductor connector for helically convoluted coaxial transmission lines is provided that bonds and seals an adapter to the coaxial line, preferably using solder, then attaches an O-ring sealed outer fitting that terminates in a standard flange. The outer conductor connector adapts a helically convoluted coax to a second O-ring seal in order to support dry nitrogen cable fill. Assembly with ordinary shop tools is facilitated. Center and outer conductors may be cut to the same length, wherein cut length is noncritical. The outer conductor connector includes an adapter that allows the use of a broad range of inner conductor connectors for nonconvoluted center conductor.

### FIELD OF THE INVENTION

The present invention relates generally to radio frequency transmission lines. More particularly, the present invention relates to mating couplings for convoluted transmission lines.

### BACKGROUND OF THE INVENTION

Coaxial radio-frequency electromagnetic signal transmission line, hereinafter “coax,” is available in a wide range of sizes, including many that are helically convoluted. Convoluted coax exhibits attenuation levels acceptable for many applications across a rather broad frequency range. Helically convoluted coax has a particular advantage in comparison to nonconvoluted coax of allowing a moderate amount of flexure without a significant change in its electrical impedance or attenuation rate. This attribute balances against an intrinsic attenuation rate somewhat higher that that of a comparable nonconvoluted coax. A coax in which a helically convoluted outer conductor surrounds an inner conductor, which may be convoluted or nonconvoluted, exhibits a characteristic impedance to radio frequency electromagnetic signal propagation that is proportional to the ratio of the mean inner diameter of outer conductor to the mean outer diameter of the inner conductor.

Transmission lines used for broadcasting are, in some but not all instances, filled with solid or foamed thermoplastic dielectric material. This dielectric material serves to center the center conductor in the coax. Some coaxes may use instead an open spiral wrap of a dielectric material. This configuration can also provide substantially continuous centering of the inner conductor. The spiral wrap style, when used with pressurized dry air or dry nitrogen, can, in addition, reduce restriction to air flow and thereby help keep water out of the transmission line. This, in turn, reduces contamination and corrosion and slows system degradation.

Connectors for transmission lines used for relatively high power applications benefit from close and continuous impedance matching to the transmission lines they connect, since mismatches resulting in reflections can be physically destructive as well as serving to degrade signal quality. Interfaces between mated connector halves and between connector halves and their transmission line elements can benefit from good gas seal qualities, as well as good electrical coupling, in order to minimize the amount of makeup gas that must be pumped into a transmission line system that may extend for a kilometer or more, and which may have several or many such interfaces.

Some existing styles of connectors for joining helically convoluted coax outer conductors exhibit any of several drawbacks. One such drawback is significant gas leakage. This can stem from deliberate omission of effective sealing, such as in connectors intended for use inside dry, climate-controlled buildings. Excessive leakage can also be intrinsic, that is, sealing deficiency due to flaws in design concept or execution. Excessive leakage can also be attributable to complex or difficult assembly, increasing likelihood of installer error. Therefore, assembly complexity, due to use of many parts, many procedure steps, or unusual operations, can lead to excessive leakage.

Accordingly, it is desirable to provide a method and apparatus that use common tools to assemble a helically convoluted coaxial transmission line outer conductor connector half, that provides a consistent and robust sealing system, and that reduces parts count.

### SUMMARY OF THE INVENTION

The foregoing needs are met, to a great extent, by the present invention, wherein in one aspect an apparatus is provided that in some embodiments provides a helically convoluted coaxial transmission line outer conductor connector half, assembled using common tools, which achieves a consistent and robust sealing system, and which provides a generally low parts count.

In accordance with one embodiment of the present invention, an outer-conductor connector half for providing a sealable, mating interface to a helically convoluted coaxial cable having an outer conductor that is helically convoluted and an inner conductor that is one of helically convoluted and smooth is provided. The connector half comprises a helix adapter having an outer surface, an inner surface, a first end face proximal to the coaxial cable, and a second end face distal to the coaxial cable. The helix adapter further comprises an inner helix sealably mateable to an outer surface of an outer conductor of the helically convoluted coaxial cable. A first outer body is sealably mateable to the helix adapter and is sealably mateable to a second outer body. The first outer body has a longitudinal axis.

In accordance with another embodiment of the present invention, an outer-conductor connector half for providing a sealable mating interface to a first helically convoluted coaxial cable outer conductor is provided. The connector half comprises first means for adapting a first helically convoluted coaxial cable outer conductor to present a first screw thread and a first sealing O-ring mating surface. The first adapting means has a longitudinal axis. The connector half further comprises first means for sealingly bonding the cable-to-screw thread adapting means to the first outer conductor and first means for interfacing the first screw thread to a first flanged face. The first flanged face is orthogonal to a longitudinal axis of the first interfacing means. The connector half further comprises first means for sealing the first interfacing means to the first adapting means.

In accordance with yet another embodiment of the present invention, a method for sealably joining first helically convoluted coaxial line to a second helically convoluted coaxial line is provided. The method comprises the steps of providing a first adaptation of a first helically convoluted coaxial cable outer conductor to present a first screw thread, providing for a first seal between the first cable-to-screw thread adaptation provision and the first cable outer conductor, providing a first interface between the first cable-to-screw thread adaptation provision and a first flanged face, and providing for a first seal between the first cable-to-screw thread adaptation provision and the first interface provision using a first O-ring.

There have thus been outlined, rather broadly, certain embodiments of the invention in order that the detailed description thereof herein may be better understood, and in order that the present contribution to the art may be better appreciated. There are, of course, additional embodiments of the invention that will be described below and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as in the abstract, are employed for the purpose of description and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as such equivalent constructions do not depart from the spirit and scope of the present invention.

### BRIEF DESCRIPTION OF THE DRAWINGS

FIG. 1 is a perspective view illustrating an assembled helically convoluted coaxial transmission line outer conductor connector half according to a preferred embodiment of the invention.

FIG. 2 is a perspective view of an assembled outer conductor connector half wherein the components are shown cut by a section plane, and wherein the coaxial line is shown unassembled to the connector.

FIG. 3 is a perspective view showing two complete outer conductor connector halves and a center conductor connector to complete a joint.

FIG. 4 is an exploded perspective view of an outer conductor connector half wherein a quadrant defined by section planes has been removed.

### DETAILED DESCRIPTION OF THE PREFERRED EMBODIMENT

The invention will now be described with reference to the drawing figures, in which like reference numerals refer to like parts throughout. An embodiment in accordance with the present invention provides a substantially sealed outer conductor connector half for helically convoluted power coaxial transmission line. The invention is scalable for use with many sizes of convoluted line. Larger sizes of coax may typically be substantially air-filled, with the center conductor held in place by an open spiral of dielectric material that stabilizes the center conductor, positions the center conductor at the center of the coax despite bending, and keeps the center conductor from rotating in response to particular levels of applied torque. Some sizes of coax may accomplish many of these functions using foamed or solid dielectric.

Center conductors for larger coax sizes are more commonly convoluted. This characteristic is used principally to increase flexibility and to decrease transverse displacement of the center conductor as the outer conductor is flexed. Nonconvoluted center conductors can be used in some smaller coaxes if the center conductors will conform acceptably when the coaxes are subjected to flexure. Thus, center conductors suitable for use with the novel connector herein described may or may not be helically convoluted.

The terms air, dry air, nitrogen, dry nitrogen, and nonreactive gas are generally used interchangeably herein, with the interpretation apparent from the context. All such terms refer generally to the same phenomenon when addressing pressurization, namely, that moisture accumulation inside a transmission line made of corrodible material such as copper is generally undesirable, and that excluding contaminants by keeping the pressure inside the transmission line slightly greater than outside pressure can preventive damage. Individual applications may call for pressurization with dry nitrogen and/or dry air, or indeed for a partially or entirely unpressurized system. As appropriate, outside air is understood to have the potential to carry water, oxygen, chemically reactive pollutants, and salt particles as well as nitrogen. Therefore, “outside air” is understood to encompass all types of air “outside” the outer conductor and/or outside a filtering and pressurization system that keeps the coaxial line filled with a desirable mixture of dry and relatively contaminant-free gases. The extent of any overpressurization used in a transmission line is an issue of user judgment.

The preferred embodiment allows inner and outer conductors of the transmission line to be cut to the same approximate, non-critical length during connector attachment. A combination of soldering and O-ring seals provides a low enough leakage rate to permit any one or more of an air compressor/dryer, a nitrogen generator, or bottled nitrogen to be used to maintain an overpressure within a transmission line.

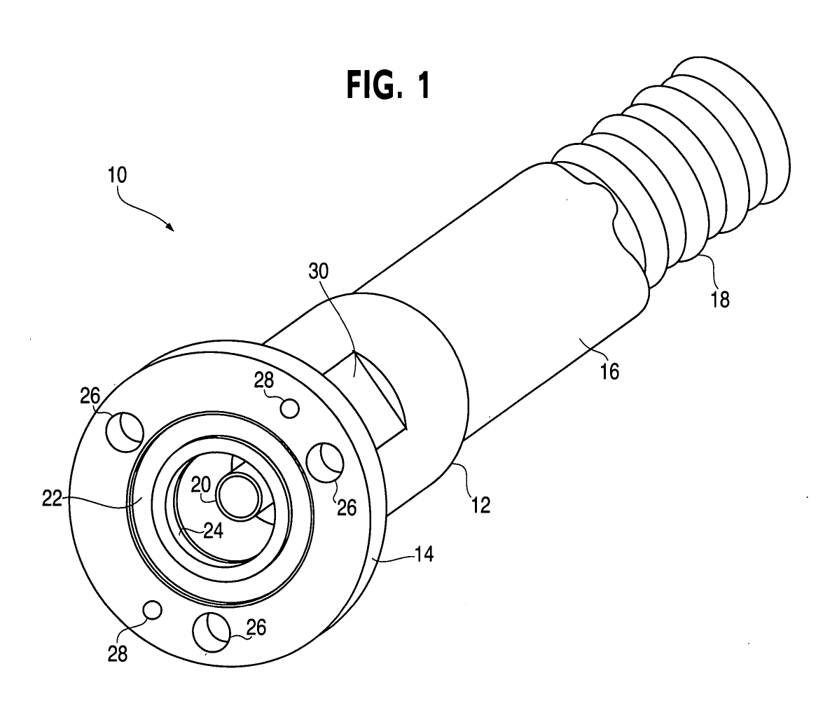

FIG. 1 is a perspective view of an embodiment of the present invention. In this view, a connector half 10 with an outer body 12 and a flange coupler 14 is fitted to a coaxial cable outer conductor, of which the jacket 16 is shown. The metallic material 18 of the coaxial cable outer conductor is shown as a cutaway through some of the jacket material 16. An inner conductor adapter 20 is visible in part near the interfacial O-ring groove 22. An inner conductor connector anchor insulator recess 24 is provided in the outer body 12.

The flange coupler 14 of the connector half 10 shown in FIG. 1 accepts bolts for which bolt holes 26 are provided. The use of bolted flanges may be a suitable arrangement for connectors in some size ranges. Electronic Industry Association (EIA) Recommended Standards (RS)-225 (50 ohm) and RS-259 (75 ohm) provide for optionally altering the number of attachment bolts as well as the bolt size for larger flange coupler 14 sizes. During assembly, alignment pins (not shown) can be placed in optional alignment pin holes 28 provided for in the EIA standards. After assembly, the pins may be removed, and in some application environments may be replaced by hanger bolts (not shown) by which the mated connector half 10 is suspended from a tower or other structure.

It should be noted that a connector half 10 made in accordance with the present invention may be mated to a connector half of another style, provided the styles are mechanically intermatable. Electrical compatibility and suitability for use in a pressurized-air environment are also factors affecting intermatability.

It may be observed that the O-ring groove 22 depth can accept roughly half of the thickness of an O-ring of a preferred size, while the anchor insulator recess 24 can similarly accept about half of the thickness of an anchor insulator. This arrangement conforms to EIA RS-225 and RS-259 standards and their International Electrotechnical Commission (IEC) successor standards, which use symmetrical mating faces at a coax outer conductor joint and which trap an O-ring and an anchor insulator in the mating plane.

Alternate, non-EIA, non-IEC embodiments are possible. A non-mirror-image embodiment could provide a mated pair of connector halves in which, for example, one flange face has a full-depth O-ring groove 22, and a mating flange face is essentially flat. Such an embodiment could similarly accommodate an anchor insulator in a full-depth anchor insulator recess 24 in one of the mated connector halves, with the other essentially flat.

Still other connector half embodiments incorporating the instant invention, which embodiments may likewise not be fully EIA/IEC standard compliant, may be preferred for some applications. Joining apparatus may include Marmon bands, bayonet or threaded coupling rings, and other clamping systems. Some attachment apparatus and methods can provide joining pressure between the flange couplers on the interfacial O-ring that is sufficiently uniform around the perimeter to assure adequate sealing.

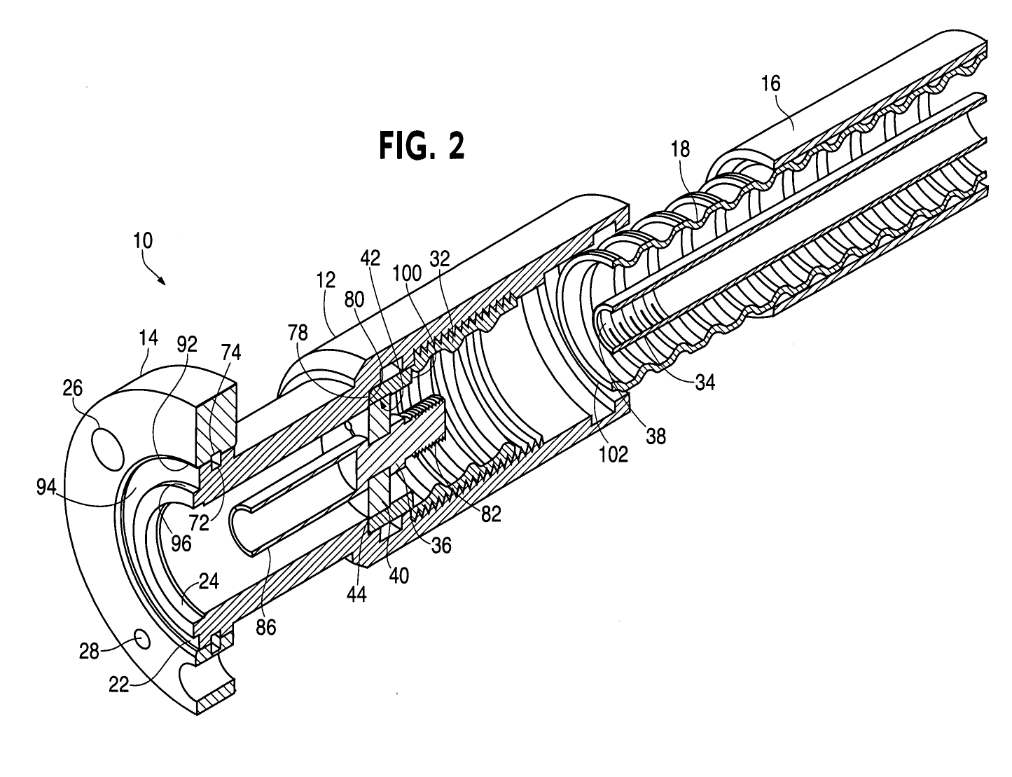

FIG. 2 is a perspective section view of an exemplary connector according to the invention, accompanied by an unsectioned cable 18. The connector half 10, which has an outer body 12 and a flange coupler 14, is joined to the coax outer conductor 18 using a helix adapter 32 that is urged helically over the helical shape of the outside of the coax outer conductor 18 until the proximal end 102 of the coax outer conductor 18 bears against the inner stop 100 on the helix adapter 32, either before or after sealing the helix adapter 32 to the coax outer conductor 18.

To better distinguish between the helical construction of the coaxial line outer conductor 18 and various screw threads used elsewhere, the term, “helix” is applied to the shape of the mating surface between the outer surface of the coax 18 and the inner surface of the helix adapter 32.

A preferred method of attachment of the helix adapter 32 to the coax outer conductor 18 is soldering. This method is well known in the art, and thus is highly likely to produce a reliable joint with a complete perimeter seal while not requiring extensive training, special equipment, and the like. Soldering generally takes place at a temperature regime that is practical even under cold weather conditions, which are comparatively common in some installation environments. For example, installing a connector 200 meters up a tower at −30 degrees Celsius with a 40 km/hr wind blowing, while sheltered by a canvas work tent, would not be unusual. For such environments, epoxies and other temperature-critical adhesives, as well as welding, brazing, and other bonding technologies, may be less desirable than such techniques as applying a propane torch flame to a subassembly and feeding solder until a continuous peripheral joint is visible. Nonetheless, for other applications, other bonding and sealing technologies may be preferable. Similarly, alternative technologies that do not use a bonding material for sealing may be practical for still other applications, such as inside a climate-controlled shelter separated from any weather-exposed coaxial lines by airtight baffles.

The coaxial cable inner conductor 34 of FIG. 2, shown nonconvoluted, receives an inner conductor extender 36. The embodiment shown uses a threaded inner conductor extender 36, so that the inner conductor is tapped 38 to allow the devices to mate. As the inner conductor extender 36 is assembled into the inner conductor 34, an inner conductor extension anchor insulator 40 fits into a recess 42 provided therefor. When the extender 36 is fully seated and secured, the insulator 40 is generally fully seated within the recess 42.

Positive, durable union between the inner conductor extender 36 and the inner conductor 34 can combine good electrical contact with the option of later disassembly if needed. Various joining styles may be used. For example, in a preferred embodiment, the inner surface of the inner conductor 34 can be tapped with a screw thread 38 of suitable pitch, which may be an extra-fine machine screw thread. This thread 38 will be formed or cut partway into the material of the inner conductor 34. The inner conductor 34 in such an embodiment is commonly copper, although some brasses and other materials are suitable for some applications. A mating thread 82 on the inner conductor extender 36 allows the extender 36 to be screwed into place, while the thread 82 proportions allow the extender 36 to bind effectively to the inner conductor 34 with moderate applied torque. The ability of the inner conductor to accept torque applied during the installation of the inner conductor extender may be achieved through the presence of spiral-wrap dielectric spacing material (not shown) between inner and outer conductors, for example.

Inner conductors 34 in smaller sizes can retain adequate bending capacity for some applications without being convoluted. For larger sizes, a helically convoluted shape similar to that of the outer conductor 18 material generally reduces stiffness appreciably. Threads formed into the innermost surface of helically convoluted metallic tubing, such as by tapping, can provide stability and retention comparable to threads formed into smooth tubing, and thus can provide adequate electrical and mechanical integrity for installing an inner conductor extender 36 into an inner conductor 34.

Following the seating of the center conductor extender 36, which establishes electrical and mechanical continuity for the center conductor 34, the outer body 12 in the preferred embodiment is screwed into place. This establishes electrical and mechanical continuity for the outer conductor 18 while fixing the dimensions for assembling the connector half 10 to a mating unit. A shoulder 44 on the outer body stabilizes the center conductor extender anchor insulator 40 when tightening is complete.

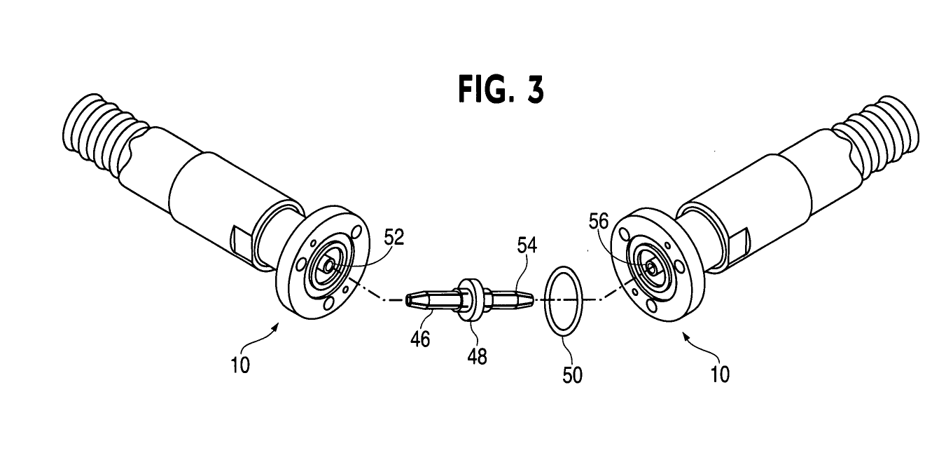

FIG. 3 is a view of two fully assembled outer conductor connector halves 10 according to the preferred embodiment and an inner conductor connector 46 over which an inner conductor anchor insulator 48 is fitted. An interfacial O-ring 50 provides a seal when the inner conductor connector 46 is fitted into a first one of the inner conductor extenders 52, the interfacial O-ring 50 is fitted in place, and the two outer conductor connector halves 10 are urged together, fitting the second end of the inner conductor connector 54 into the second inner conductor extender 56. Additional details concerning the O-ring groove 22 and the inner conductor anchor insulator groove 24 may be observed in FIG. 2.

The tubular section 86 of the inner conductor extension 36 (see FIG. 2) provides a mount for attaching the coax center conductor connector 46. The center conductor connector 46 may have a variety of other properties not addressed in detail herein, such as the ability to slide longitudinally with little mechanical friction while maintaining low electrical resistance and inserting only a small impedance lump. Several center conductor connectors 46 for nonconvoluted center conductors exist, and development of further such connectors 46 may be anticipated. The standard configuration of the tubular section 86 of the extension 36 allows many such known and future center conductor connectors 46 to be used with the embodiment.

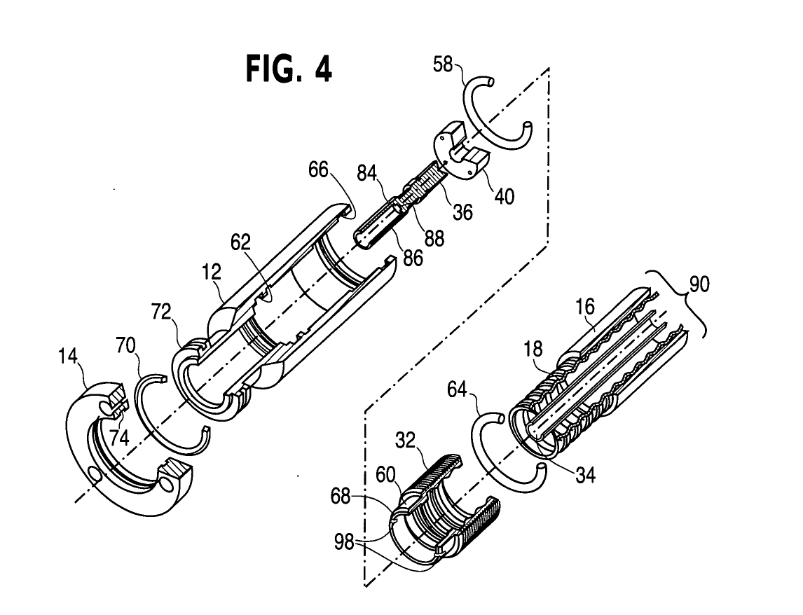

FIG. 4 is an exploded section view further showing the first internal O-ring 58 that establishes a seal between the O-ring sealing surface 60 of the helix adapter 32 and the first O-ring recess 62 of the outer body 12. The second internal O-ring 64 fits similarly into the second O-ring recess 66 of the outer body 12. The second O-ring 64 passes over the outer insulation 16 of the outer conductor 18 during assembly. With the first O-ring 58 fitted into the first recess 62, a chamfer 68 eases passage of O-ring 58 onto the O-ring sealing surface 60.

A substantially airtight seal between the coax 18 and the outer body 12 may be realized. This seal, as well as the seal between mating connectors, may be further augmented through use of a lubricant compatible with the silicone, nitrile, Viton®, or other elastomer of which the O-rings 50, 58, and 64 may preferably be made. Such a lubricant, if substantially nonvolatile, nonhardening, and nonreactive over the range of temperatures and other environmental conditions to which connector halves 10 are subjected, serves to fill some voids, scratches, and pores in the components, further enhancing the sealing characteristics of the O-rings 50, 58, and 64.

The flange coupler 14 for the preferred embodiment is shown in FIG. 4 to be separate from the outer body 12. This permits rotation of the flange coupler 14 for alignment of the bolt holes 26 and alignment pin holes 28, shown also in FIG. 2, to the corresponding holes in the facing flange coupler 14 on the next coax section. This style of construction is commonly referred to as a swivel. Alternate swivel mechanisms to the one shown may be used. Fixed configurations may be used instead, wherein the outer body 12 and the flange coupler 14 are fabricated as a single unit or are locked together after fabrication.

Independently of the sequence for assembling the helix adapter 32 and outer body 12 to the outer conductor 18, the flange coupler 14 is affixed to the outer body 12 using a split (i.e., not continuous) locking ring 70 that fits into an outer body locking ring groove 72 and a flange locking groove 74. The locking ring 70, when uncompressed, is roughly equal or slightly greater in diameter than the flange locking groove 74, so the locking ring 70 presents a retaining edge after assembly to establish the swivel function. For a typical installation, the locking ring 70 is expanded and fitted over and into the outer body groove 72, then compressed, such as with piston ring compression tool or the like, into the outer body groove 72 as the flange coupler 14 is slid into place. If the flange coupler 14 is allowed to displace the compression tool, the locking ring 70 can be prevented by the flange coupler 14 from expanding until it reaches the flange groove 74. The relative depths of the grooves 72 and 74 are evident as they are shown in FIG. 2. Alternate procedures can likewise cause the outer body 12, flange coupler 14, and locking ring 70 to be put together into a unified swivel or fixed assembly. Some styles of continuous locking rings 70 may also be suitable for this assembly.

The helix adapter 32 may fit somewhat loosely over the outside of the coax outer conductor 18 during assembly, although heating the parts together and filling any gap between them with solder or other bonding material during assembly can generally establish a seal. Where the fit between the helix adapter 32 and the outer conductor 18 exhibits interference, however, a tool such as a pin or blade spanner, fitted into recesses 98 in the helix adapter 32, may be useful to seat the helix adapter 32 fully onto the outer conductor 18 prior to soldering or in conjunction with application of other sealing/bonding material.

The fit between the outer body 12 and the helix adapter 32 may likewise require some application of torque at the completion of assembly to assure a stable connector 10, since the O-rings 58 and 64 are in compression and may be expected to provide resistance, and because the mating shoulders 78 and 80, shown in contact in FIG. 2, on the outer body 12 and the helix adapter 32, respectively, are urged into contact during assembly. To apply the requisite torque, the flats 30 shown in FIG. 1, or holes for a pin spanner or other equivalent torque application provision and tooling, may be provided in various embodiments. Application of reaction torque to the cable and adapter assembly may require that the outer conductor jacket 16 be grasped with sufficient grip, as with a strap wrench or the like.

Other configurations of the union between the helix adapter 32 and the outer body 12, including configurations that do not use screw threads on the helix adapter 32, are possible. For example, lockable bayonet fittings, crimp bands, thermal expansion of the outer body 12, cryoshrinking of the helix adapter 32, shape memory alloy construction, Magnaflux® forming, captivation of outer body 12 components that clasp around a helix adapter 32, and other attachment systems may each be suitable in some embodiments.

Application of controlled and calibrated torque to the inner conductor extender 36 may preferably require a torque application feature. One type of torque application feature, shown in FIG. 4, is at least one hole 84 drilled transversely or obliquely through the extender 36 in such a way that the at least one hole 84 breaks through the bottom of the tubular portion 86 of the extender 36 and provides a screwdriver slot 88 for applying a calibrated torque. Other torque application features that can be put in the bottom of the tubular portion 86 of the extender 36 may include, for example, a slot or a hexagonal “bolt head” shape cut into the bottom, as with a milling machine, a hole pair drilled into the bottom and usable with a pin spanner, or another feature to accommodate another, preferably common, torque application tool.

Other provisions for retaining an inner conductor extender 36 in an inner conductor 34 can be suitable, such as clamping apparatus similar to that used in bicycle arts for retaining the quill of a handlebar stem within the steerer tube of some bicycle forks.

The characteristic impedance of a coaxial cable 90 increases logarithmically with the ratio of the mean diameter of the outer conductor 18 inner surface to the (mean) diameter of the inner conductor 34 outer surface. Therefore, it is possible, by choosing the same diameter ratio for the connector parts as for the corresponding coax parts, to maintain a largely unchanged characteristic impedance in the connector, even if the actual diameters are different. Impedance irregularities, such as the lump caused by the recess 42 (see FIG. 2) that retains the extension anchor insulator 40, can create compensatable impedance error nodes detectable as RF reflections.

The characteristic impedances of the coax 90 and the connector 10 are proportional to the inverse of the square root of the dielectric constant, which may be air or nitrogen in the case of both the coax 90 and the connector 10, and which may thus have a dielectric constant almost identical to that of free space, namely 1.00. The anchor insulators, however, are preferably made from some dielectric material, such as polytetrafluoroethylene (PTFE), known as TEFLON®, which has a dielectric constant different from air/nitrogen/vacuum. It may be further noted that the dielectric “constant” tends to vary slowly with frequency in real dielectric materials. As a result, the dielectric material and dimensions used for the extension anchor insulator 40 may be selected to reduce the magnitude of the error caused by impedance irregularities at frequencies of greatest interest.

As seen in FIG. 2, an interflange joint according to the preferred embodiment uses elements that are integral in part with the outer body 12 and in part with the flange coupler 14. That is, while the outer body 12 has a cutout 22 to accommodate roughly half of the thickness of an interflange O-ring 50, the outer wall 92 of the O-ring cutout 22 is located on the flange coupler 14. The radial face 94 of the O-ring cutout 22, in conjunction with the inner wall 96 and the outer wall 92, compresses the O-ring 50 (shown in FIG. 3) to establish a seal. No additional seal between the flange coupler 14 and the outer body 12 is required in the embodiment shown to achieve coax-to-coax sealing between two identical connector halves 10.

Although an example of the connector 10 is shown using helically convoluted copper outer conductor 18 and either a smooth or a convoluted copper inner conductor 34, it will be appreciated that other materials than copper can be used for this coax 90. Similarly, although a preferred material for the outer conductor connector 10 is one of a family of soldering-compatible brass or bronze alloys, it will be appreciated that materials other than brasses and bronzes may be preferable for each of the parts of the connector 10. Also, although the connector half 10 is useful to join coaxial lines 90 carrying moderate to high-power radio frequency signals between sources such as transmitters and loads such as broadcast antennas where ability to tolerate a moderate amount of flexure is a desirable transmission line attribute, the connector half 10 can also be used for electrical power transmission at a variety of frequencies for such applications as reactors, cyclotrons, and other high-energy research and manufacturing activities, as well as for radio frequency electromagnetic signal transmission in applications where moderate transmission line flexure is not needed.

Embodiments of the instant invention that support the use of unjacketed coaxial cable 90 can use a cushion or other material in place of or in addition to the second internal O-ring 64 to provide mechanical stabilization at the cable end of the outer body 12. Methods such as heat shrinking or overmolding elastomeric material onto the cable 90 at the point of termination, for example, permit a secondary seal to be maintained with respect to the cable-to-cable joint.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. An outer-conductor connector half for providing a sealable, mating interface to a helically convoluted coaxial cable having an outer conductor that is helically convoluted and an inner conductor that is one of helically convoluted and smooth, wherein the connector half comprises:
a helix adapter comprising:
an outer surface;
an inner surface;
a first end face proximal to the coaxial cable;
a second end face distal to the coaxial cable, and
an inner helix sealably mateable to an outer surface of an outer conductor of the helically convoluted coaxial cable; and
a first outer body having a longitudinal axis, wherein said first outer body is sealably mateable to both said helix adapter and a second outer body.

2. The connector half of claim 1, further comprising a flange coupler that is coupled to said outer body.

3. The connector half of claim 2, wherein said flange coupler is rotatably coupled to said outer body.

4. The connector half of claim 1, further comprising:
a center conductor adapter; and
an anchor insulator that substantially centers said center conductor adapter at a substantially fixed position with respect to said helix adapter inner surface.

5. The connector half of claim 1, wherein said helix adapter inner surface further comprises a stop surface terminating said inner helix partway along said helix adapter inner surface.

6. The connector half of claim 4, wherein said helix adapter inner surface further comprises a mating surface to mate with an outer wall of said anchor insulator.

7. The connector half of claim 1, wherein said helix adapter inner helix further comprises a material that can be one of soldered and bonded to the coaxial cable outer conductor outer surface to form a substantially leak-free, sealed joint.

8. The connector half of claim 1, wherein said helix adapter outer surface further comprises a helix adapter outer screw thread.

9. The connector half of claim 1, wherein said outer surface of said helix adapter further comprises:
an O-ring sealing surface; and
an O-ring lead-in bevel.

10. The connector half of claim 1, wherein said helix adapter second end face further comprises a contact shoulder that contacts said outer body.

11. The connector half of claim 1, wherein said outer body further comprises a first O-ring group, wherein said first O-ring group comprises:
at least one first-group O-ring groove; and
at least one first-group resilient O-ring configured to seal said outer body to said helix adapter.

12. The connector half of claim 11, wherein said outer body further comprises a second O-ring group, wherein said second O-ring group comprises:
at least one second-group O-ring groove; and
at least one second-group resilient O-ring configured to seal said outer body to an outer surface of a jacket covering the outer conductor of the helically convoluted coaxial cable.

13. The connector half of claim 8, wherein said outer body further comprises a female screw thread threadedly mateable to said helix adapter outer screw thread.

14. The connector half of claim 1, wherein said outer body further comprises:
a mating face extending substantially perpendicularly to said longitudinal axis of said outer body, and located distal to the coaxial cable, by which mating face said outer body is configured to mate to an outer body of another connector half;
a partial-depth O-ring groove in said outer body mating face configured to accept an interfacial sealing O-ring in part; and
a partial-depth mating recess configured to accept a center conductor connector anchor insulator in part.

15. The connector half of claim 2, wherein said flange coupler further comprises an attachment mechanism by which said flange coupler can fasten structurally to a flange coupler of another connector half.

16. The connector half of claim 15, wherein said attachment mechanism is a plurality of radially distributed bolts, wherein a longitudinal axis of each of said plurality of bolts is parallel to said longitudinal axis of said flange coupler.

17. An outer-conductor connector half for providing a sealable mating interface to a first helically convoluted coaxial cable outer conductor, comprising:
means for adapting a helically convoluted coaxial cable outer conductor to present a screw thread and a sealing O-ring mating surface, wherein said adapting means has a longitudinal axis;
means for sealingly bonding said cable-to-screw thread adapting means to said outer conductor;
means for interfacing said screw thread to a flanged face, wherein said flanged face is orthogonal to a longitudinal axis of said interfacing means; and
means for sealing said interfacing means to said adapting means.

18. The connector half of claim 16, wherein said adapting means further comprises:
means for centeredly positioning an anchor insulator between said adapting means and said interfacing means; and
means for centeredly suspending a center conductor adapter from a location radially inward from an anchor insulator positioning means.

19. A method for sealably joining a helically convoluted coaxial line to a second coaxial line, comprising the steps of:
providing an adaptation of a helically convoluted coaxial cable outer conductor to present a screw thread;
providing for a seal between the cable-to-screw thread adaptation provision and the cable outer conductor;
providing an interface between the cable-to-screw thread adaptation provision and a flanged face; and
providing for a seal between the cable-to-screw thread adaptation provision and the interface provision using an O-ring.

20. The method of claim 19, further comprising the steps of:
providing for a seal between the flanged face and the interface provision;
providing for centered positioning of an anchor insulator between an adapter and an interface provision; and
providing for centered suspension of a center conductor adapter from a location radially inward from an anchor insulator positioner.

21. The method of claim 20, further comprising the steps of:
providing for interposition of a sealing O-ring between the flanged face and a mating flange face joined to the second coaxial line;
providing an electrical connection between the center conductor adapter and one of a corresponding center conductor adapter joined to the second coaxial line and a center conductor of the second coaxial line; and
providing for clamping of the flanged face to a flanged face of an outer conductor connector joined to the second coaxial line.

22. The method of claim 21, wherein the second coaxial line outer conductor is helically convoluted.

23. The method of claim 21, wherein the second coaxial line outer conductor is one of nonconvoluted and convoluted using nonhelical convolutions.

24. The method of claim 21, wherein the method for preparing the second coaxial line for mating is substantially identical to the method for preparing the first coaxial line for mating.
